(19) United States
(12) Patent Application Publication
(10) Pub. No.: US 2006/0246955 A1
(43) Pub. Date: Nov. 2, 2006

(54) Mobile communication device and method therefor

(76) Inventors: Mikko Nirhamo, Kempele (FI); Sami Paihonen, Kempele (FI); Heikki Haveri, Tampere (FI); Juha Pusa, Kaugasala (FI); Katja Konkka, Tampere (FI); Katja Leinonen, Tampere (FI); Romel Aminch, KBHV (DK); Nina Maki, Pirkkala (FI)

Correspondence Address: PERMAN & GREEN, 425 POST ROAD, FAIRFIELD, CT, 06824, US

(21) Appl. No.: 11/120,319

(22) Filed: May 2, 2005

(51) Int. Cl. H04B 1/38

(52) U.S. Cl. 455/566

(57) ABSTRACT

Methods, systems and mobile communication devices for the operation of mobile communication devices; such a method including: providing an operable display area on a mobile communication device; displaying an array of one or more selectable items in said operable display area; displaying an array of features for said selected one item; and providing for highlighting a selected one item of the said one or more selectable items and/or features.

This invention relates to improved presentation, navigation, selection and/or operation options for portable communication devices, particularly, user interface options involved on the display screens thereof.

### BACKGROUND

Personal portable communication apparatuses in the form of mobile or cellular telephones have become extremely popular and are in widespread use throughout the world. Moreover, mobile telephones have evolved from just portable analogues of traditional fixed-line telephones, no longer providing only voice communication, rather now having been developed into multi-faceted communication and alternative function devices providing a large range of communication options including wide area network (e.g., internet) access as well as other functionalities such as music playing (e.g., MP3 format), inter alia.

Currently, it is very common for portable communication devices such as mobile phones or terminals to have, preloaded on/in a memory of the phone, content relating to one or more optional communication or other data-handling alternatives that can be operated on the mobile phone through the phone's User Interface (UI) usually involving a display and keys. Such pre-stored functionalities may be accessed via navigation through the phone's various menu options for selection of the particular electronic and/or software application to be operated. Certain keys of the mobile phone's keypad may be assigned control functionality for accessing and/or controlling certain predetermined features of the application in relation to other features of the application.

### SUMMARY

According to a first aspect of the invention there is provided a method of or system for operation of a mobile communication device; the method including: providing an operable display area on a mobile communication device; displaying an array of one or more selectable items in said operable display area; providing for the selection of one item of said one or more selectable items in said display area; highlighting the selected one item of the said one or more selectable items; displaying an array of features for said selected one item.

In such a method or system, there is thus provided improved presentation, navigation, selection and/or operation options for the mobile communication device.

According to another aspect, methods and/or systems hereof include an operator or user process for using a mobile communication device; including operation steps of: initiating application control software on the mobile communication device, the application control software including rules for operation affecting the user interface of and/or the operation of a software application on the mobile communication device; whereby the rules for operation include the presentation of an operable display area on a mobile communication device; the display of an array of one or more selectable items in said operable display area; provision for the selection of one item of said one or more selectable items in said display area; highlighting the selected one item of the said one or more selectable items; and, display of an array of one or more functional operations for said selected one item; and, further operational steps of selecting one of the one or more selectable items to thereby also display the array of one or more functional operations therefor; operating the selected item by selecting and activating one the one or more functional operations.

In this way, the operator's selection and/or operation of the mobile communication unit are improved.

According to a still further aspect, mobile communication devices hereof include a housing with a user interface including a display and a keypad disposed on the housing; control software disposed within the housing of the mobile communication device, the control software including rules for operation of the mobile communication device; whereby the rules for operation include the presentation of an operable display area on a mobile communication device; the display of an array of one or more selectable items in said operable display area; provision for the selection of one item of said one or more selectable items in said display area; highlighting a selected one item of the said one or more selectable items; and, display of an array of one or more functional operations for said selected one item; whereby the mobile communication is operable according to the rules of operation by selecting one of the one or more selectable items to thereby also display the array of one or more functional operations therefor; and operating the selected item by selecting and activating one the one or more functional operations.

Such mobile communication devices thus provide one or more of improved presentation, navigation, selection and/or operation options for the mobile communication device.

### BRIEF DESCRIPTION OF THE DRAWINGS

For a better understanding of the present invention and to understand how the same may be brought into effect reference will now be made, by way of example only, to the accompanying drawings, in which:

FIG. 1A provides an isometric illustration of a first embodiment of a hand portable phone or personal communication terminal according to the invention;

FIG. 1B schematically shows parts of a hand portable phone for operability including internal functionalities as well as communication with a network;

FIG. 2, which includes the sub-part FIGS. 2A, 2B and 2C, schematically shows display functionality of an embodiment of the invention;

FIG. 3, which includes the sub-part FIGS. 3A and 3B, schematically shows display functionality of another embodiment of the invention;

FIG. 4, which includes the sub-part FIGS. 4A and 4B, schematically shows display functionality of yet another alternative embodiment of the invention;

FIG. 5, which includes the sub-part FIGS. 5A, 5B, 5C and 5D, schematically shows display functionality of a still further embodiment of the invention; FIG. 6, which includes the sub-part FIGS. 6A, 6B and 6C, schematically shows display functionality of yet still one further embodiment of the invention;

FIG. 7, which includes the sub-part FIGS. 7A, 7B and 7C, schematically shows display functionality of a still further embodiment of the invention;

FIG. 8, which includes the sub-part FIGS. 8A, 8B, 8C, 8D and 8E, schematically shows display functionality of yet still one further embodiment of the invention;

FIG. 9, which includes the sub-part FIGS. 9A, 9B and 9C, schematically shows display functionality of a still further embodiment of the invention;

FIG. 10, which includes the sub-part FIGS. 10A, 10B and 10C, schematically shows display functionality of a still further embodiment of the invention; and,

FIG. 11, which includes the sub-part FIGS. 11A, 11B and 11C, schematically shows display functionality of yet still one further embodiment of the invention.

### DETAILED DESCRIPTION OF THE INVENTION

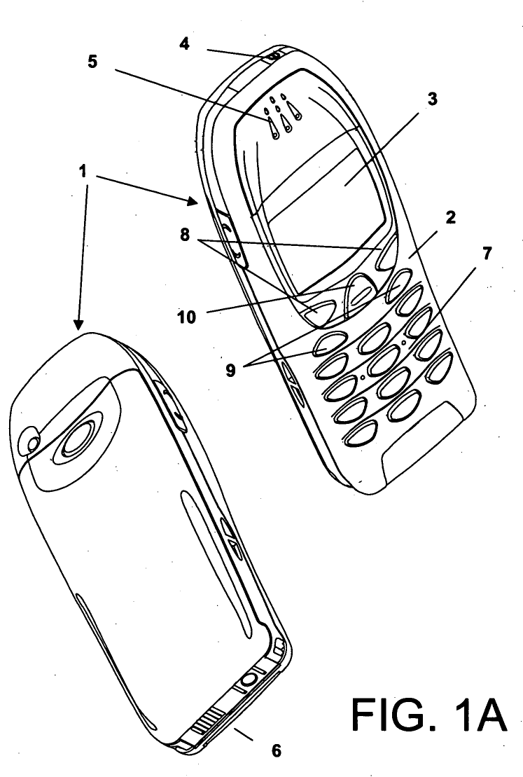

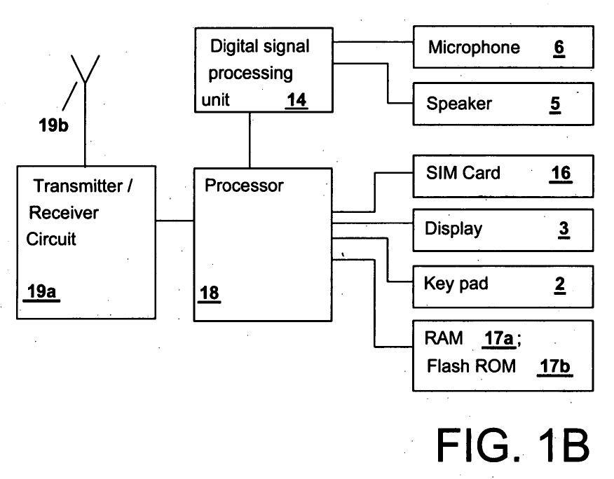

FIG. 1A shows a preferred embodiment of a portable personal communication apparatus in an exemplar form of a mobile or a cellular phone 1, hereafter also alternatively referred to as a handset or a wireless terminal 1, which may be used for standard mobile telephony as well as for alternative functionalities according to the present invention as is described in some detail hereafter. The wireless terminal comprises a user interface which may include a keypad 2, a display 3, an on/off button 4, a speaker 5 (only structural openings are shown), and a microphone 6 (only structural openings are shown), inter alia.

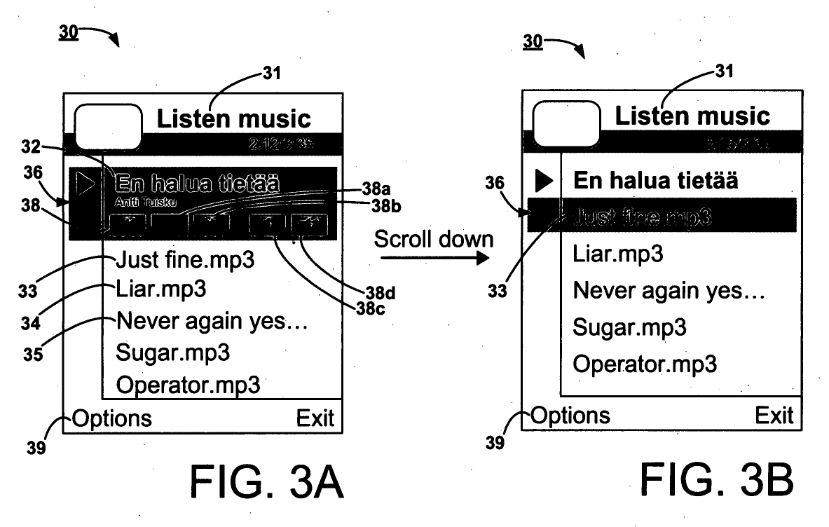

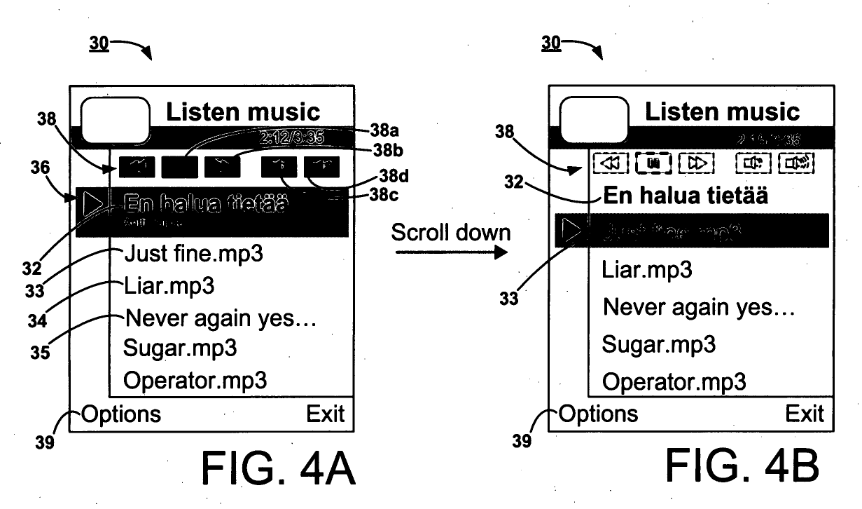

According to a first embodiment of the invention, the keypad 2 has a first group 7 of data entry buttons or keys as alphanumeric keys, two softkeys 8, and a scroll-key 10 (up/down and/or right/left and/or any combination thereof) for moving a cursor in the display 3. An alternative hereto may be a four-way button, an eight-way button or a joystick, track ball, roller or other cursor controller (none of which being shown here). Touch screen functionality could also be used. The functionality of the softkeys 8 (sometimes referred to as selectkeys) may be shown in a separate field in the bottom (or other area) of the display 3 just above the softkeys 8 (see the example in FIGS. 3 and 4, below). Furthermore the keypad may include one or more, or as shown here, two call-handling keys 9 for initiating and terminating calls, inter alia.

FIG. 1B schematically shows some of the more important parts of a preferred embodiment of a phone 1. A processor 18, which may preferably support GSM terminal software (or alternatives thereto), also controls the communication with a network via a transmitter/receiver circuit 19a and an antenna 19b. The microphone 6 receives the user's speech into analogue signals; the signals transmitted thereby are A/D converted in an A/D converter (not separately shown) before the speech is encoded in an audio processing part 14. The encoded speech signal is transferred to the processor 18 which then provides for the encoded speech signal to be communicated via the transmitter/receiver 19a and an antenna 19b to the network and the intended recipient. Going the other way, in receiving an encoded signal from the network via the transmitter/receiver 19a, the audio part 14 speech-decodes the signal, which is transferred from the processor 18 to the speaker 5 via a D/A, converter (not separately shown).

The processor 18 may also form the interface to the keypad 2 and the display 3, and a SIM card 16, as well as preferably to a RAM memory 17a and/or a Flash ROM memory 17b, (and other possible devices for data, power supply, etc. (not separately shown)). The memory devices 17a and/or 17b may be used to store software applications and/or the data for use therewith. Particularly as may be applicable to the present invention, such software applications and/or data may include one or more of, inter alia, the software and/or data for an organizer and/or a contacts list, e.g., a phonebook, address book; call lists containing lists of calls made, received and/or missed; email and/or SMS software and/or email messages, SMS messages sent and/or received; a calendar for appointment or other calendaring data, as well as one or more other functionality applications, data and/or information, either in the form of one or more stored functional software applications and/or the data related to a particular functionality, as for example MP3 music files and an MP3 music player to play those files. Other mobile communication unit applications may include inter alia, MPEG-viewers (or other movie or audio/visual format viewers), or radio applications, a Gallery, or File manager, and/or a message handler that could show a preview of the message.

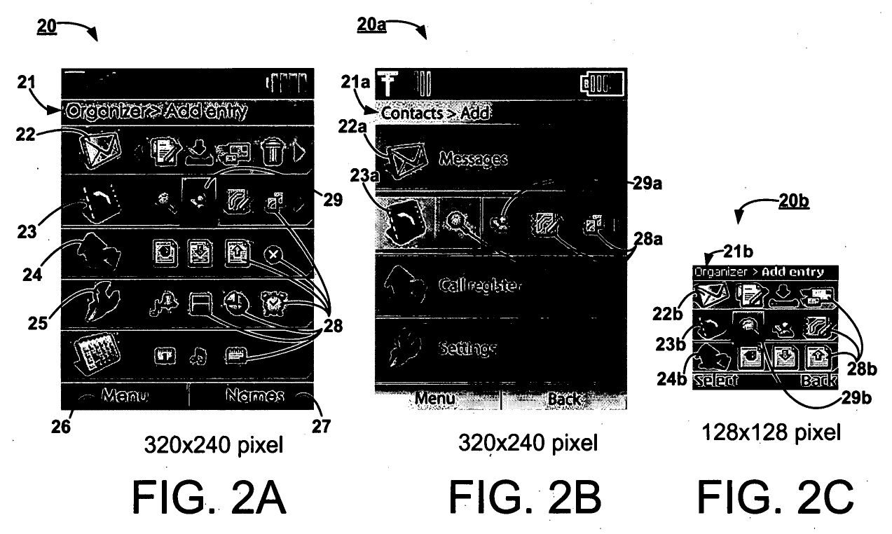

Implementation of one or more of such functionalities depends on the capabilities of the particular handset. As a first example, starting with a handset 10 which has one or more functionalities, at least one such functionality having at least one subordinate level of either functionalities or other selection opportunities for the user of the handset, a user in terface (UI) hereof provides a simplified scheme for accessing such subordinate selections. In particular, this first example provides for merging the primary and subordinate or secondary levels of user selectable items/actions into one level. As presented for example in FIG. 2, see first FIG. 2A, a display 20 is shown with a number of application elements 22, 23, 24 and 25 (and potential unidentified others shown and/or unshown) in a vertical orientation here. Each of the application elements may be selectable items which may further have as shown here one or more subordinate elements or features, generally identified as elements 28, extended horizontally across the display. Elements 28 may also be selectable. Each respective horizontal line of elements 28 corresponds to a respective application element 22-25 (etc.) as a grouping or assemblage of subordinate or secondary elements thereof. Thus, the horizontal elements are displayed in direct relationship to the respective horizontal grouping identifiers thereof.

Traditionally, application elements such as elements 22-25 would occupy an entire menu or screen display without any indication of the relative subordinate elements available thereunder (this being true regardless whether in list, grid or single main menu item display form). Then, to reach such subordinate elements, a user would first need to select a particular application element 22-25 and then be presented a secondary screen display (not shown) having presented there the available subordinate elements to be chosen. This would thus have been a two-step process which is now eliminated (or substantially so) with the present invention display of both the primary elements 22-25 together with an arrangement of the subordinate elements 28 thereof.

These primary and subordinate elements have also been referred to as respective levels, e.g., levels one and two of a menu structure. This invention thus solves the problem of going in and out of menu levels, i.e., going between level one and two, back and forth, by merging level one and two into one level thereby providing views and selectability of items in both simultaneously. The advantage is that you only have one level, i.e., one UI display that the user needs to relate to, thereby providing a faster and simpler navigation, selection and operation process.

Note, the example of FIG. 2A provides some additional information as for example when a particular icon or element 29 is selected. This element 29 may then be highlighted is some way (as here by a distinctively colorized box framed therearound, although other means are also usable herewith). This example thus shows how an operator may skip the usual first step in a conventional two-step process of first selecting the group (here an “Organizer” group as represented by the icon 23) and then being presented with an array of choices including the desired selection 29 (here an “Add Entry” icon 29). Note, a dialogue line 21 may be presented to show the user verbal definitions of the icon(s) selected (here, “Organizer” and “Add Entry” as described). Moreover, selectkey (see keys 8 described for FIG. 1 above) user areas 26, 27 can be used as well to indicate to the operator an assortment of available selectable actions with the particular item 29 or items 28 to be selectable and operated upon.

A similar though slightly distinct example 20a is given in FIG. 2B where only a single horizontal line of selectable secondary features 28a is shown, usually only one such line at a time in this example. Thus, an operator may move an up/down key or joystick (up or down) to arrive at a particular desired grouping of selectable items (here indicated by the Organizer icon 23a with a corresponding presentation of several horizontally disposed secondary items 28a. Then, the user may use right and/or left movement keys or a joystick (right or left) to arrive at a desired selection which is then highlighted, see icon 29a. The non-selected primary elements or groups, see e.g., element 22a, may have verbal definitions thereof presented instead of the presentation of subordinate items to assist the user in appreciating the category of choices available. The movement of an operator onto such a grouping (up and/or down movements) may then call for a substantially automatic change to the presentation of the list of subordinate selections as shown for grouping 23a. Similarly, here as well as in FIG. 2A (and 2C, below), the movement, left or right, onto a particular selection may then provide for substantially automatic change in the presentation in the dialogue area 21, 21a (and 21b, in FIG. 2C) to provide a word description corresponding to the selected item.

Note, the selection of a grouping e.g., grouping 23 in FIG. 2A and grouping 23a in FIG. 2B, can also be indicated as by highlighting with darker background (FIG. 2A) or lighter background (FIG. 2B) or otherwise. Such a selection can be merely indicative of movement through (e.g., up and/or down) through the list, or may be indicative of an actual confirmation of selection as may occur on the depression of an appropriate key, selectkey, joystick or the like.

Note, as shown in FIG. 2C, this UI style can work with both small displays (see the 128×128 pixel display 20b thereof) as well as for the larger displays (though it may be preferable for use in bigger displays). Fewer grouping icons 22b, 23b, 24b are availably shown with fewer corresponding lateral or horizontally available subordinate icons 28b and 29b. In such situations, as is also true even for bigger screens such as those in FIGS. 2A and 2B, when more items are available than can be shown at any particular time, small arrows (or the like) may be used at the right and left side of the screen (see the right facing black arrows on the right side of the horizontal rows of groupings 22 and 23 of FIG. 2A, as well as the left facing grey triangles on the left sides of the same groupings) which provide for moving the horizontal row of items in a fashion to hide presented, members and show hidden members for alternative selectability.

Note, the present convention of having the main menu (level one) pointing in a vertical direction and the second level in a horizontal direction is non-limitative as the opposite orientation may also be useful, i.e., having the primary menu elements horizontally disposed and the subordinate selections disposed vertically. Other arrangements or orientations may also be used, whether having the primary elements arrayed along any side (left, right, top or bottom) or otherwise (e.g., centrally) or whether separate groupings of primary elements and corresponding subordinate elements are dispersed at intervals, e.g., as in separate boxes, across or around the screen.

A second example of improved user interface (UI) presentation for improved navigability, selectability and operability is shown in FIGS. 3 and 4 where a handset 1 of the invention may include a software application for handling music and/or MP3 format downloads, uploads and/or which can set up and/or play a music or MP3 file. Even so, other primary applications can also use the following arrangement of icon presentation and operability as well, as where a list of items to be operated upon is to be presented and one or more activatable actions applicable to one or more members of that list are available to provide the operation thereof. Thus, other sorts of applications may make use of the structure and/or methods of the presently described examples, including MPEG-viewers, or other movie or audio/visual format viewers, or radio applications, photo Galleries, or File Managers, and/or a message handler that could show a preview of the message, inter alia.

FIG. 3, including FIGS. 3A and 3B, shows a first embodiment of a display 30 which would be displayed in a wireless terminal display area 3 like that indicated generally in FIG. 1. The display 30 may, as in this example, include display of a header or other indicia 31 notifying what current software application is currently being run. Also shown may be one or more (e.g., a list) of selections or selectable items, here e.g., MP3 files 32, 33, 34 and/or 35, inter alia (including those shown and/or unshown in FIG. 3), which may be played with/on/by the software application. (Note, the item/song 32 from FIG. 3 entitled “En halua tietaa” is a Finnish song by the Finnish artist Antti Tuisku.) The selectable items 32-35 here are database items upon which actions or functions of the overall application may be performed.

Particularly apropos here is a further feature of the present invention wherein a dynamic or multifunctional highlight can be used in the simplification of the presentation, navigation, selection and/or operation of one or more of the listed items/files. FIG. 3 presents a music/MP3 playlist example with such a dynamic highlight. In this first example of a means for implementation of the present invention, a generally highlighted area 36 is shown which provides, only in direct relationship to a specific item, here item or MP3 file 32, an expanded display of a multifunctional set 38 of features, here, operational icons, e.g., icons 38a, 38b, 38c and 38d. These operational icons 38 in being operational are thus selectable as well. The focus of such a highlighted area 36 is then placed upon the currently played item, here item 32, and the operational icons 38a-38d associated therewith. An alternative addition to the selecting of a particular item may be the presentation of other features, e.g., information, in the highlight or other associated space for the selected item, as for example the artist name relative to the selection 32 in FIG. 3A. Note, the other selectable items, e.g. items 33, 34, 35, inter alia, have contrasting non-highlighted representations.

Note, up and down keys or a multi-directional key (see e.g., key 10) or other input device (joystick, roller, etc.) moves the focus/highlight area 36 in and through the list. See e.g., FIG. 3B, where the next lower option 33 has been highlighted, noting that here, an alternative of the current invention is shown where the functional icons 38 are not yet shown but rather awaiting a confirmation of the selection by a subsequent depression of a selection key, e.g. a softkey 8. This is in alternative to a potential constant re-positioning of a group of functional icons 38 within a highlight 36 at any point of correspondence with a selectable item, as highlighted, whether merely highlighted or actually selected. In this case it may be preferred for the select key to provide the primary function shortcut.

In a preferred embodiment, the highlighted area 36 provides/contains most if not all available primary functions operable with the particular software application and/or the selectable item(s) usable therewith. These functions are then represented in the displayed highlighted area 36 with icons; see e.g. icons 38a-38d. The operator or user of the phone can then initiate or otherwise change the desired function to be used directly in the highlighted area 36 using phone cursor control keys, such as for example, an arrow key or keys, see multidirectional key 10 in FIG. 1 (alternative multidirectional keys, joysticks, rollers etc. or individual right and left or up and down keys may otherwise be used as well). The functions represented by the icons may be relatively generic or may be content sensitive, i.e., may be specific to the particular software application and listed items used therewith.

In the particular example of FIG. 3 which shows involvement with a music or MP3 player application, the functional icons, here exemplified by icons 38a-38d, may represent a music play/pause button 38a, fast forward button 38b (rewind shown but not separately identified), and/or sound level control 38c (softer) and 38d (louder). Thus, in this example, the user can move an emphasized or otherwise highlighted cursor or visual selection representation (here shown by bolding and/or the darker coloring of the play/pause button 38a) to select the desired functional operation to be performed for the selected item 32 (here, the playing of the song entitled “En halua tietää”). As shown here, the user can move the focus inside the highlight with right and left arrow keys, pressing a selection key, such as for example, a select or softkey 8 (shown in FIG. 1) performs the corresponding function.

Note, if there are several primary functions or groups of functions relative to a particular application or array of selectable items, the options button 39 may be opened when pressing the corresponding select key, to select which function or group of functions to apply. Another option for the user is to open menu (options list) and find the function there.

An alternative embodiment may be as shown in FIG. 4 and involves the highlight 36 being multifunctional through and for the entire list of selectable items 32-35. As shown in FIG. 4A, this highlight area 36 is associated with a first selectable item 32 as in FIG. 3A; however, the functional icons 38 are removed to a discrete location, here above the list of selectable items. Then, in scrolling down to a second selectable item 33 as shown in FIG. 4B, the highlight area 36 moves thereto, but the functional icons 38 (here shown in dashed lines) remain above, or at least may be activatable in the same position upon the selection (as by the depression of a select key) of a particular desired item 32 or 33, e.g. Note, other embodiments are also available as where the highlight 36 does not move but rather the selectable items are moved, e.g., scrolled, thereinto. In such a case the highlight 36 and the icons 38 need neither move and indeed may alternatively be in a similar space, as for example, where the highlight also highlights the icons 38. Note here also that a consequence of selecting a particular item may bring other information into the highlight or other associated space for the selected item, as for example the artist name relative to the selection 32 in FIG. 4A.

Note that although this functionality is shown in FIGS. 3 and 4 relative to a music playing application, this feature could also be used for various alternative applications. For non-limitative examples, note that similar functionalities can be incorporated with MPEG-viewers (or other movie or audio/visual formats) with the same basic operationality. Similarly, this could be used with a radio application where the functions might include: manual tune up/down, automatic tune up/down, change band, change preset station; or with a Gallery (as for photo viewing) or other File Manager including functions such as: open, edit, delete, send, rotate, zoom; and/or with a message handler, that could show a preview of the message, functions including: open, forward, reply, delete, inter alia.

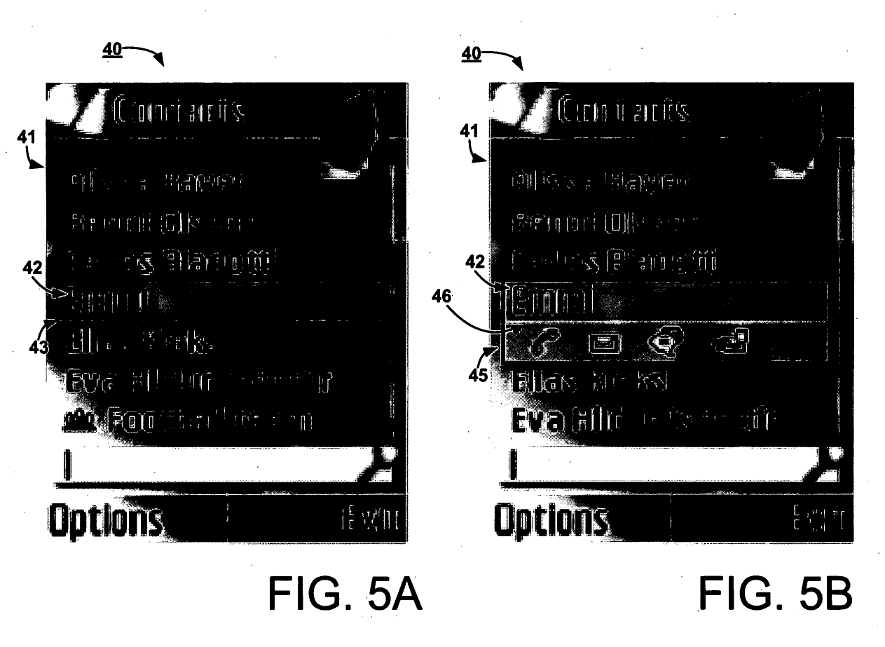

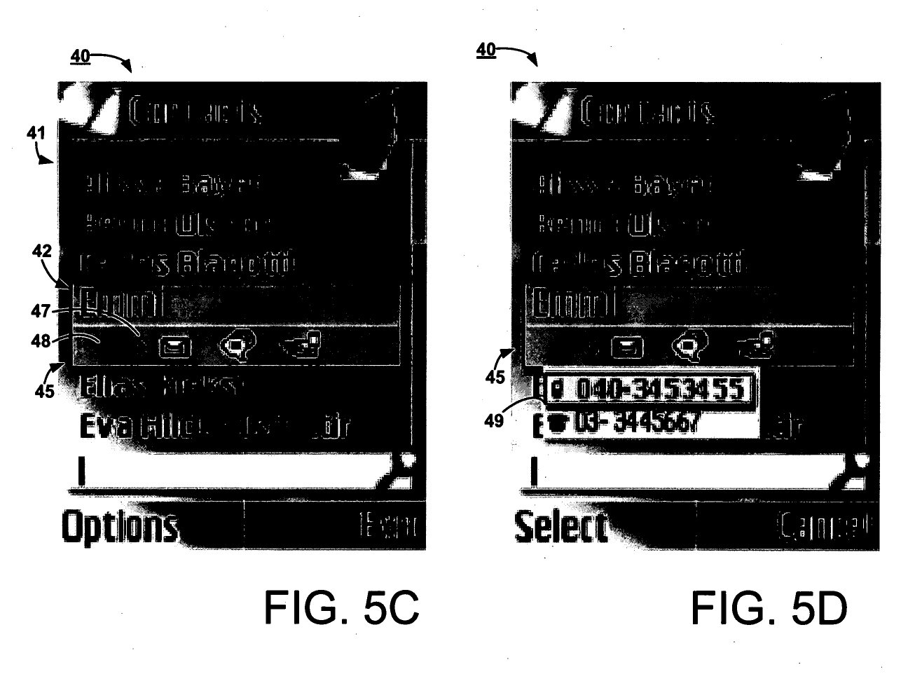

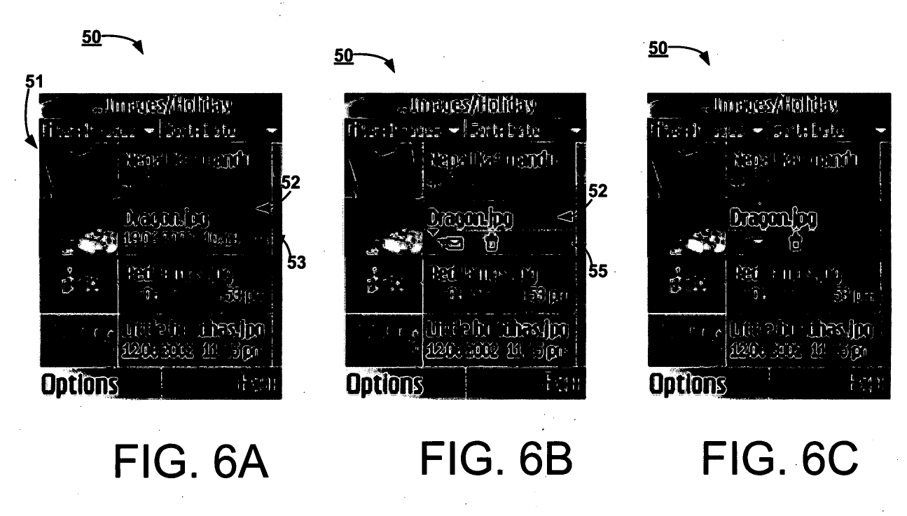

As further examples of implementations of improved operator interface functionality similar to that of FIGS. 3 and 4, the various sub-part FIGS. 5A-5D of FIG. 5 depict usage of a dynamic highlight functionality like that of FIGS. 3 and 4 in use with a Contacts list. Note, other single-line item lists could and usually would work similarly. In such a single-item listing, the display 40 including a list 41 as shown first in FIG. 5A, a focus 43 (by gleaming, color or brightness or other highlight change) is placed on an item 42 in the list 41. Then, after a time period, also referred to as a timeout (the duration of the timeout may be of is not defined in this document), a functional highlight 45, also hereafter referred to as a “toolbox” 45, appears as shown in FIG. 5B. This toolbox 45 may be made to substantially automatically appear as the focus is stopped on the item in question, here item 42. Then, it may be that the toolbox 45 appears as an expansion of the list item 42, and shows functional (or other) options related to the item.

The toolbox 45 may preferably have indicative arrows to quide navigation directions. Initially, the toolbox can be accessed by using down arrow key, see the down arrow indicator 46 in FIG. 5B. Left-right arrow keys (see key indicator 47 in FIG. 5C) provide for navigation between toolbox items. Toolbox items can be selected by pressing select key, see the gleaming phone icon 48 of FIG. 5C (note, the toolbox may preferably not interrupt select-function of the item in question.). Further functionalities may be provided by popup, see popup box 49 in FIG. 5D, here depicting two alternative telephone numbers to be selected from for calling the listed person. Though not shown in FIG. 5, a tooltip (a written explanation of an icon in question) may be used as help for understanding the icons in the toolbox 45. Such a tooltip may be made to appear if focus stays on a certain icon for a pre-selected or pre-defined time. When in toolbox, e.g., after having started navigation therein, pressing the up or down keys may be made to take the focus to the next item/object above or below in the list 41 (e.g. to the next contact in the Contacts list shown).

In a double item list, such as the list 51 shown in the display 50 of FIG. 6 (including FIGS. 6A-6C), the toolbox 55 (FIG. 6B) may appear after a timeout (perhaps automatically), as focus is stopped on the item 52 in question, see the gleamin 53 in FIG. 6A. In this case, the toolbox 55 may be made to replace the second line of the normal view of the item 52 (see FIG. 6A). As before, the toolbox 55 may show multiple options (functions, information et al.) related to the item. Also as before, the toolbox 55 can be accessed by using down arrow key, and, left-right arrow keys may provide navigation between toolbox items. Preferably, the toolbox may have indicative arrows to quide navigation directions, see FIG. 6C, in a fashion like that described for FIG. 5, above.

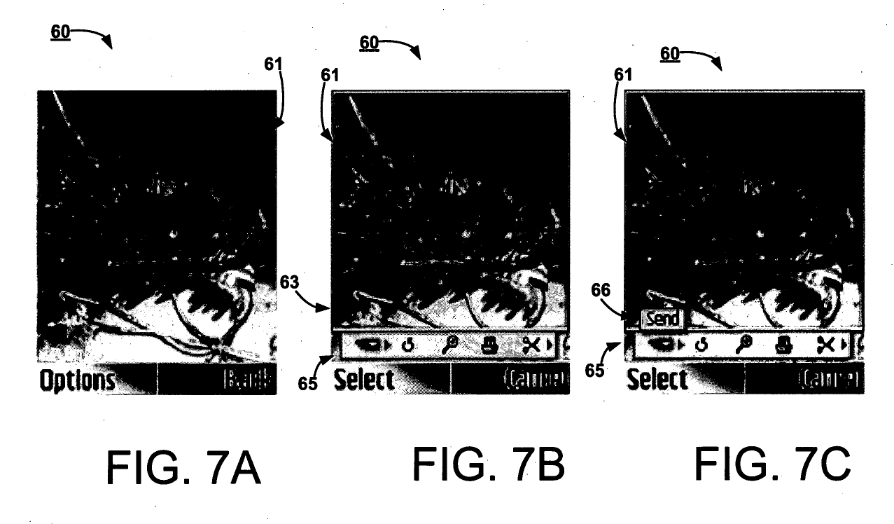

In a still further example, as shown in FIG. 7 (including sub-part FIGS. 7A, 7B and 7C), the user interface (UI), see display 60, may be placed in a full screen mode with an object 61 (e.g. viewing pictures, editable or otherwise), a toolbox 65 can be activated. Pressing the select key may be used to activate the toolbox 65 which may then appear as shown in FIG. 6B (note the optional gleaming 63 to show the activation relative to the entire object 61). As before, left-right arrow keys may provide for navigation between toolbox items, the toolbox preferably having indicative arrows to quide navigation directions. As shown in FIG. 7C, a tooltip 66 can be used for help in understanding icons. As before, toolbox items can be selected by pressing the select key. The right soft key “Cancel” can be used to deactivate the floating toolbox 65.

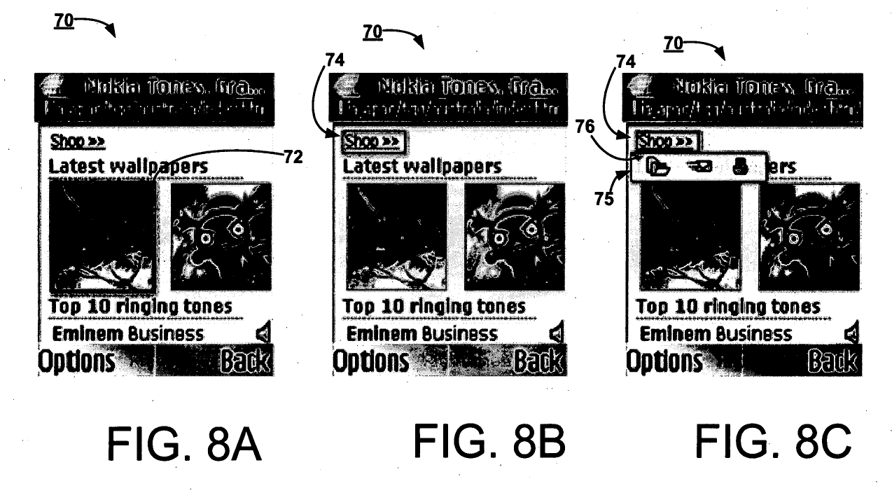

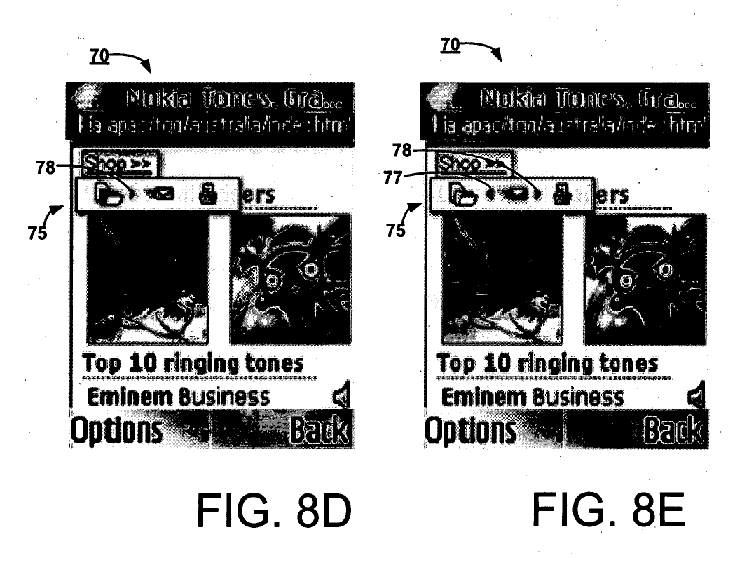

The toolbox concept may also be used in object browsing situations, as when browsing between objects (e.g. pictures, or web links). As shown in FIG. 8 (including sub-part FIGS. 8A-8E), the toolbox 75 may be activated (perhaps automatically) after a timeout when an object in question, see object 72, is focused upon. As before, the toolbox 75 can be accessed by using up-down arrow keys depending whether toolbox is below or above the object in focus. When operating in the toolbox 75, pressing a down key can then take operation to an item/object below (e.g. to the next link). Left-right arrow keys may provide navigation between toolbox items, preferably using indicative arrows.

A more particular description of the example shown in the display 70 of FIG. 8 includes first a depiction in FIG. 8A of common browsing on a world wide web (WWW) site, with a focus 72 on a selected link. Then, dependent upon the navigation options of the browser, a category 74 of options can be selected. Either upon selction, or after a timeout automatically, the toolbox 75 may be made to appear. An arrow indicator 76 may indicate the possibility of navigating to the toolbox 75 by using down arrow button on the phone. As before, left-right arrow indicators 77, 78 as shown in FIGS. 8D and 8E may provide for navigation between items in toolbox. These indicative arrows help a user to visualize navigation directions. Notice also the gleaming of the icons in FIGS. 8D and 8E which indicates the focus on the particular respective action.

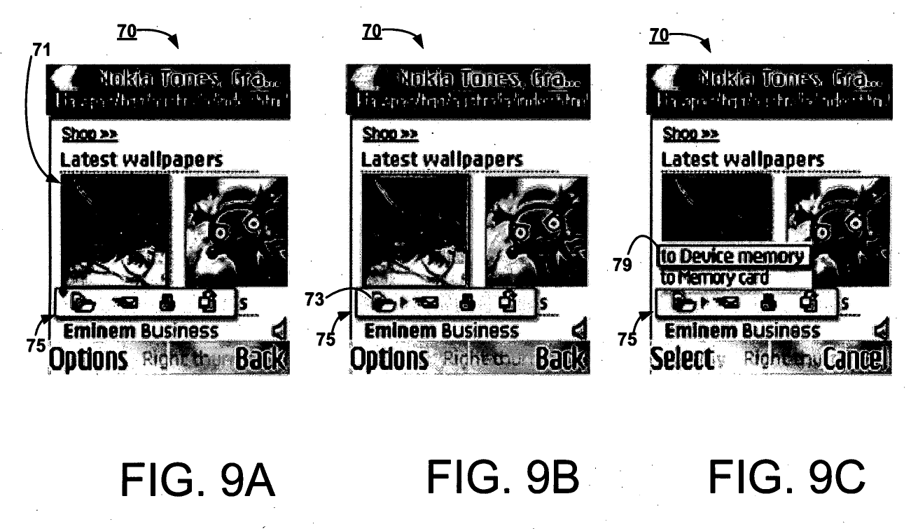

A slightly distinct example is shown in FIG. 9, including sub-part FIGS. 9A, 9B and 9C. Here, the focus is shown on a certain picture 71 in the display 70; see FIG. 9A. The toolbox 75 may appear automatically after a time out. The user may navigate down to the toolbox as in the previous examples. As shown by the gleaming icon 73 in FIG. 9B, the user selects a function (here, an exemplar save-function). Then, as shown in FIG. 9C, a pop-up list 79 (here, a list of: “to Device memory” or “to Memory card”) appears.

In each of these examples, the toolbox provides for visualizations of the options a user has related to each selected user interface (UI) item and enables direct access to those. In the prior art, these options could only be found under separately activated menus. The toolbox may but preferably does not offer options that are inaccessible with the selected item. More general menu listings can be made shorter as some of its items are presented in the toolbox.

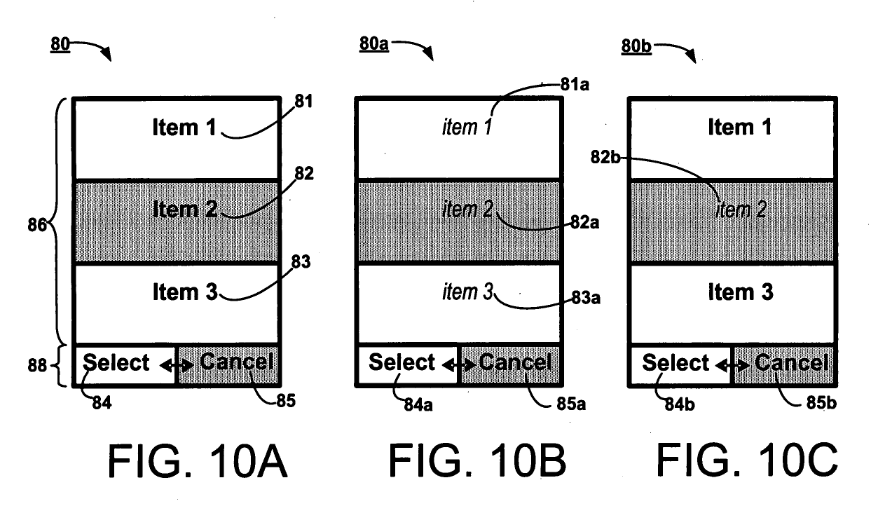

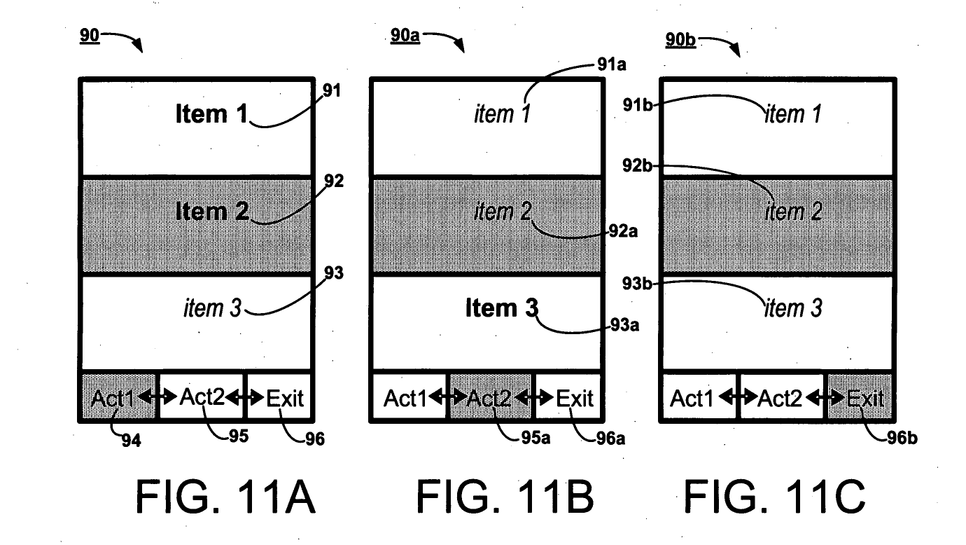

As still further examples of implementation of improved user interface operability, FIGS. 10 and 11 show the general concept of what is here denominated as a multi-focus list control in a UI style of the present invention. Generally, focused-upon items are shown here marked with dotted backgrounds (though these could be highlighted otherwise, e.g., by being brightened or gleamed relative to other selection alternatives or by being presented in a distinctive colour, or other style, inter alia). Up and down keys of a joystick (or other cursor movement implementation such as a four or eight way button) can be used to select the establishment of a focus or highlighting on an item, e.g., “Item 1” element 81, “Item 2” element 82, and/or “Item 3” element 83. Left and right keys can be used to select focus or highlighting on an action, as e.g., the “Select” element 84 and the “Cancel” element 85 in FIG. 10; and “Act 1” 94, “Act 2” 95 and “Exit” 96 in FIG. 11. In these embodiments, the “items” 81, 82, 83 may be considered as either selectable items or features as these terms are used throughout. Similarly, the “actions” 84, 85 and/or 94, 95, 96 hereof may also though opposingly be considered either features or selectable items. If such “actions” are features, they will generally also be selectable. In any situation the user can press the middle button of the joystick (or 4/5 way or 8/9 way button arrangement) or an alternative selectkey or the like, to trigger a highlighted action. Note also indicated generally in FIG. 10A is the vertical listing of items, here also known as a focus area 86; and the horizontal list of available actions, here also known as a focus area 88.

FIG. 10A, however, illustrates in display 80 a situation where the improvements proposed by the presently described embodiments of this invention are not present (either not disposed to be operative therewith, or alternatively not activated as described below). In other words, related focused upon or highlighted items and focused upon or highlighted actions are similarly shown simultaneously, with dotted backgrounds here, without any further highlighting or definition or visual delineation as described herebelow. Note, the highlighted item in FIG. 10A is “Item 2” element number 82 and the highlighted action is the “Cancel” action 85.

FIG. 10B; on the other hand, provides a display 80a which has the same general situation as FIG. 10A but with some additional visual improvements as provided by this invention. Items in the list 86, see particularly items 81a, 82a, and 83a, are de-emphasized or dimmed in FIG. 10B, as indicated here by the distinctive less bold font, so that the user knows they are not part of the possible or intended “Cancel” action suggested here by the action focus/indication on the “Cancel” action element 85a. If the user presses the left action key (see softkeys 8, FIG. 1A), here corresponding to the “Select” action 84a, the items become available, becoming un-dimmed (such as those un-dimmed items 81, 82 and 83 shown in FIG. 10A), and the action indication becomes focused on “Select,” by changing the focus indication from the “Cancel” to the “Select” action (this indication is not shown). Such lack of de-emphasis or dimming shows the direct relationship of the action, here “Select”, to the items upon which such action may be run. If the user presses either the up or down key, the items in the item focus area 86 become available (not subject to “Cancel”), the action becomes focused on the “Select” action alternative 84 or 84a and the focused item becomes either one of “Item 1” or “Item 2” or “Item 3,” with an appropriate indication (dotted background or the like, shown only for “Item 2” here) thereof depending on which key the user pressed.

FIG. 10C, in display 80b, shows the same general situation again, but with an alternative visual implementation of the present invention. Here only the currently focused item is de-emphasized or dimmed when the action indication is focused on “Cancel.” See “Item 2” element number 82b. This de-emphasis shows the direct relationship of the action “Cancel” to the highlighted item 82b, specifically, that the action is not applicable to the item. The alternative if the action “Select” were highlighted (not shown) and the item 82b selected would result in a lack of de-emphasis or no dimming, thus showing the direct relationship of the availability of the action to be performed on the item. Such a visual clue is perhaps not equally as strong as in FIG. 10B where all of the selectable items were dimmed, but in providing such a limited indication, it may provide a better signal for the user that he or she can use the up and/or down keys to directly alter the focus onto the item list and an alternative item thereof, which would also result in a change of focus in the action field, away from the “Cancel” action 85b and to the “Select” action alternative 85a.

FIG. 11 shows a more general situation that is possible to implement using the concept of FIG. 10. Though generally, one or more actions may be available, here the list control is shown having more than two available actions performable relative to one or more of the items in the list of items (even though in many cases the number of possible actions may be only two where the first one is the actual action and the other one is a way to exit the situation). Here, each action may thus have its own set of items it can affect. Choosing a different focus in the action field dims different items in the list.

See for example, the display 90 of FIG. 11A which shows three items 91, 92 and 93, where however, the third such item 93, “item 3,” is shown dimmed (indicated by the distinctive, less-bold font). This is dimmed when the first action in this example, here “Act 1,” element 94, is highlighted (see the dotted background thereof), thereby indicating that item 93 is unavailable for or otherwise incompatible with operation by “Act 1” 94. The other two shown items 91 and 92 are not dimmed and thus available for and/or compatible with selection for operation with “Act1” 94; indeed, the “Item 2” element number 92 is highlighted and thus ready to be acted upon if and when the Act1 action is commenced.

FIG. 11B shows in a display 90a an alternative situation when for example the “Act2” element 95a has been selected and then corresponding unavailable items 91a and 92a (“items 1 and 2) are dimmed. This may then signal to the operator to select another item from the item list which is available, see e.g., “item 3,” element 93a, thus moving the highlight from “item 2” 92a (as shown) to the “Item 3” (not shown). Similarly, FIG. 11C shows in display 90b what may occur if the “Exit” action element 96b is selected. Here all of the items in the list are then dimmed; see items 91b, 92b and 93b.

What is thus described for the embodiments of FIGS. 10 and 11 are user interfaces having. a form of a multi-focus list control. In a general form of multi-focus list control, the focus may be set in two dimensions at the same time, where one dimension is used for selecting a focus on a particular action and another dimension is used for selecting focus on the target, i.e. item, of the action. The actual triggering of an action on an item can be done after selecting the focus in both dimensions. In one view, the dimension used for selecting focus on the action can replace the functionality that would normally be provided by soft keys (see keys 8 in FIG. 1A) in a similar system.

Nevertheless, in such general forms of multi-focus list control, the mere presentation of multiple focuses may provide some undesirable consequences which may negatively affect the behaviour and/or usability of the UI control. Rather, it might not be totally clear to the user what happens with each alternative the control offers to the user. Also accidental changes of the focused action may easily happen without the user noticing it. Hence the risk of accidental user actions rises and the usability of the device suffers. For example: when there are multiple actions available in a multi-focus list control and one of the actions is to exit, it is likely that the exit action is not targeted to any of the items in the list. However, if the user is still able to select focus on the list of items when exit action is focused, it may become unclear to the user what happens if he/she exits with a different item focused-upon. On the other hand, if the user accidentally focuses on exit but is still able to select an item, he/she may think that the action being triggered is something else.

Thus, as described for FIGS. 10 and 11, the detriments of the multi-focus behaviour of the UI control can be reduced by providing action specific functionality. This may be especially true when the multi-focus control provides a possibility to exit without doing anything. The action specific functionality consists of two parts: visual hints and automatic focus management.
1. Visual Hints:
   When the user changes the focus of action to exit, the focus on the item list can be dimmed. More generally, it is possible to dim all the items in the list that the currently focused action has no effect to. In the case of exit, this would mean dimming all the items.
2. Automatic Focus Management
   When the focus of action is on exit (and the list of items is dimmed), the user may still want to select an item and hence most probably trigger some action on it. In this case, the user can directly use the normal mechanism for selecting focus on an item. This automatically changes the focus of action away from exit to the default action.

There may be many advantages to visual hints, as for example, the user being capable of seeing that a currently focused-upon action is not targeted to be operable with some specific item in the list. Also, it becomes visually quite clear that a focused-upon action has changed. An advantage of the automatic focus management includes providing for the user to not have to first move the action focus away from any action before being able to select an item.

In general portable communication devices are becoming more complex, yet it remains desirable to keep the user input mechanisms as simple as possible. Hence the use of multi-focus controls may be an attractive alternative.

This may more particularly apply to user interfaces with complex functionality but limited input capability, one such example being the clamshell type of phones. The user interface (UI) style of clamshell phones is limited by the physical input capability of the phone when the cover UI is active, i.e., when the lid of the clamshell is closed. The main way of navigating and making selections in such a UI system is to use only a 4- or 5-way button or joystick (5-way is 4 directions plus a middle button). Thus, this invention may be easily applied to user interfaces with complex functionalities but limited input capabilities, particularly such as in clamshell phones.

All of these alternative embodiments may be contrasted to prior navigation and operation systems, where commands are usually in a menu structure, as most user interfaces are mainly based on navigation with lists and initiating the commands from the menu, and, the selection key provides the primary function or a menu subset list. However, it may sometimes have been unclear for the user what function is performed with the selection key. The advantages here are efficiency and obvious presentation of the available primary functions.

In a basic case, the phone(s) 1 are operable by a user, as per the keypad inputs 2 (including for example one or more of the keys 7, 8 and/or 9) to send controlling commands through use of the buttons/keys of the mobile unit or a joystick on the phone, if available. Changes may also be effected by pressing keys/buttons dedicated for such purpose. Instead of using the special selection keys for moving and selecting functions, alphanumeric keys as otherwise integrated in the phone may be implemented for this additional purpose according to other embodiments of the invention.

An application could or would also be run by software on the phone 1 and may establish or have established rules and/or situations generally for operation. An Application Program Interface (API) may then handle the connectivity between the program application and the user interface, particularly handling the inputs communicated therethrough and the outputs presented thereto.

It may further be noted that the highlight representations, icons or words, displayable as described above may be displayable simply on relatively blank backgrounds, or may be more intricately shown in relation to enriched environments. The environments may in simpler embodiments show mere selection alternatives, e.g. (simple line drawings), or may be more richly engendered (artistically or using pictorial reproductions of true backgrounds). Moreover, in more adapted versions, the backgrounds can be further active as for example being functional and/or reflective/representative of functionality through particular depictions on the display 3 of the phone 1. The highlight area/environment may have toggle effects for seeing larger or smaller or more or less magnified versions of the highlighted item, information, rules or functions, or the like. The user can then both see the icon being controlled or at least a representation of the highlighted area/environment for the selected item on the display screen.

Note, an API (application interface) between the program application and the user interface may provide the logistics, as for example to control endpoint services, inter alia. The API may also control the moving of data to and from the user interface or from the application to another software application or database or even to other communication devices, e.g., to and from other phones. Other API functionalities on the phone side may include implementation, i.e., accessing and controlling different applications. Such an API may also provide the connection logistics, as in providing a continuous observation of network connectivity and maintaining the connectivity, e.g., the disconnections may be automatically reconnected. The API may also provide an application interface between one or more phones and third party accessories, and/or other environment devices.

1. A method of operation of a mobile communication device; the method comprising:
providing an operable display area on a mobile communication device;
displaying an array of one or more selectable items in said operable display area; and,
simultaneously displaying a corresponding array of one or more features associated with a corresponding one of said one or more selectable items;
wherein the displaying of the array of one or more features is in direct relationship to the corresponding one of said one or more selectable items.

2. A method according to claim 1 wherein the selectable items are one of database items, actions, functions or groupings of applications and the corresponding array of one or more features includes one or more of individual applications, functions, actions, operations, database items or information directly related to the corresponding selectable items.

3. A method according to claim 1 wherein the one or more features are selectable.

4. A method according to claim 1 wherein the array of selectable items is one or more of a list of items or a regular or irregularly spatially dispersed grouping of items.

5. A method according to claim 1 wherein the array of selectable items are displayed using one or both of a verbal form or icons.

6. A method according to claim 1 wherein only one corresponding array of one or more features associated with a single corresponding one of said one or more selectable items is displayable at a time.

7. A method according to claim 1 wherein a plurality of said one or more selectable items has simultaneously displayed a corresponding array of one or more features associated with each of said one or more selectable items.

8. A method according to claim 1 wherein each of said one or more selectable items is on a primary level and each of said features is on one of a subordinate or secondary level.

9. A method according to claim 1 wherein the selectable items and the features are disposed in opposing vertical and horizontal arrays.

10. A method according to claim 1 wherein the selectable items and the features are disposed in opposing vertical and horizontal arrays; wherein said one or more selectable items are disposed in one of a vertical array or a horizontal array and the one or more features associated with a corresponding one of said one or more selectable items are disposed in one of a correspondingly opposing horizontal array or opposing vertical array.

11. A method according to claim 1 wherein the direct relationship of features to a corresponding selectable item is one of applications directly related to a grouping of applications; functions, actions or operations directly related to a database item to-be-operated upon; and, database items to-be-operated upon directly related to functions, actions or operations.

12. A method according to claim 1 wherein the direct relationship of features to a corresponding selectable item is one of a display of features adjacent a selectable item; a display of features only upon the highlighting of a selectable item; a display of features only upon the selection of a selectable item; and, a de-emphasis of displayed features relative to a selectable item.

13. A method according to claim 1 further comprising:
highlighting one item of the one or more selectable items; and,
displaying an array of features for said one item.

14. A method according to claim 1 further comprising:
highlighting one item of the one or more selectable items;
displaying an array of features for said one item;
providing for the selection of one of said one or more selectable items or of said features for said item; and,
selecting one of said one or more selectable items or said features.

15. A method according to claim 1 further comprising:
highlighting one feature of the displayed array of features;
providing for the selection of the one highlighted feature; and,
selecting said one feature.

16. A method according to claim 1 further comprising:
highlighting the array of features associated with the corresponding one of the one or more selectable items.

17. A method according to claim 1 further comprising:
highlighting one item of the one or more selectable items; and,
highlighting the array of features associated with the corresponding one of the one or more selectable items.

18. A method according to claim 1 further comprising:
providing for the selectability of one item of said one or more selectable items in said display area;
dynamically highlighting a selectable one item of the one or more selectable items;
displaying an array of features for said selected one item as a function of the dynamic highlighting of the one item.

19. A method according to claim 18 wherein the display of the array of features is one of adjacent the dynamically highlighted selectable item or removed to a fixed disparate display position.

20. A method according to claim 1 further including:
providing for the selectability of one item of said one or more selectable items in said display area;
dynamically highlighting a selectable one item of the said one or more selectable items;
confirming the selection of the dynamically highlighted one item; and,
displaying an array of features for said selected one item as a function of the confirmed selection of the dynamically highlighted one item.

21. A method according to claim 20 wherein the display of the array of features is one of adjacent the confirmed selection of the selectable item or disposed in a fixed disparate display position.

22. A method according to claim 1 further comprising:
providing for the selectability of one item of said one or more selectable items in said display area;
highlighting one item of the one or more selectable items; and,
highlighting with de-emphasis one or more of the array of features.

23. A method according to claim 22 wherein the highlighting with de-emphasis occurs as a function of the highlighting of the one item.

24. A method according to claim 22 further including:
confirming the selection of the highlighted one item; wherein the highlighting with de-emphasis occurs as a function of the confirming of the selection of the one item of the one or more selectable items.

25. A method according to claim 1 further comprising:
providing for the selectability of one feature of said one or more features in said display area;
highlighting one feature of the one or more selectable features; and,
highlighting with de-emphasis one or more of the selectable items.

26. A method according to claim 25 wherein the highlighting with de-emphasis occurs as a function of the highlighting of the one feature of the one or more features.

27. A method according to claim 25 further including:
confirming the selection of the highlighted one feature; wherein the highlighting with de-emphasis occurs as a function of the confirming of the selection of the one feature of the one or more features.

28. A method according to claim 1 further comprising:
providing for the selectability of one item of said one or more selectable items and of one feature of said array of features in said display area;
highlighting for selectability one or more of the selectable items of the one or more selectable items;
highlighting for selectability one or more of the features of the one or more features; and,
highlighting with de-emphasis one or more of the selectable items.

29. A method according to claim 28 wherein the highlighting with de-emphasis is a highlighting with de-emphasis of only the one or more selectable items highlighted also for selectability.

30. A method according to claim 1 wherein either one or both of the display of the selectable items or the features includes highlighting of one or more of the selectable items or features, and wherein the highlighting includes the presentation of one or more of a typeface or font alteration, bolding, italicization, underlineation, colorization, gleaming, dimming or definition of a highlighted area.

31. A method according to claim 1 wherein the displaying of an array of features includes one or both of a highlighting of the display of features and displaying the features in a highlighted area associated with the associated one of the one or more selectable items.

32. A method according to claim 1 wherein the array of features are selectable using a navigational input device on the mobile communication device.

33. A method according to claim 32 wherein the navigational input device is selected from the group consisting of discrete directional keys, a multidirectional key, a joystick, a track ball, a roller or one or more toggle switches.

34. A method according to claim 1 further including providing for the selectability of one or both of the selectable items and features, and wherein the providing for the selectability of one item or feature of said one or more selectable items or features in said display area includes the use of an input device on the mobile communication device.

35. A method according to claim 34 wherein the input device on the mobile communication device is one or more of a softkey, selectkey, call control key, navigational device or touchscreen.

36. A method according to claim 1 further including providing for the selectability of one or both of the selectable items and features, and wherein the providing for the selectability of the items or features includes the step of receiving input representing the selection of the one item from the one or more selectable items or features.

37. A computer program for carrying out the method of claim 1.

38. A software carrier for holding software according to claim 37.

39. A mobile communication device comprising a software application for operating a mobile communication device in accordance with the method of claim 1.

40. A method for using a mobile communication device; the method comprising:
initiating application control software on the mobile communication device, the application control software including rules for operation affecting the user interface of and/or the operation of a software application on the mobile communication device;
whereby the rules for operation include the presentation of an operable display area on a mobile communication device; the display of an array of one or more selectable items in said operable display area; provision for highlighting a selected one item of the said one or more selectable items; and, display of an array of one or more functional operations for said selected one item; and,
selecting either one of the one or more selectable items to thereby also display the array of one or more functional operations therefor, or one of the one or more functional operations to thereby also display by highlighting with de-emphasis the one or more selectable items the selectable items incompatible with the functional operation; and,
operating the selectable item by activating one of the one or more functional operations.

41. A mobile communication device comprising:
a housing with a user interface including a display and a keypad disposed on the housing;
control software disposed within the housing of the mobile communication device, the control software including rules for operation of the mobile communication device;
whereby the rules for operation include the presentation of an operable display area on a mobile communication device; the display of an array of one or more selectable items in said operable display area; provision for highlighting a selected one item of the said one or more selectable items; and, display of an array of one or more functional operations for said selected one item; and,
whereby the mobile communication is operable according to the rules of operation by selecting either one of the one or more selectable items to thereby also display the array of one or more functional operations therefor, or one of the one or more functional operations to thereby also display by highlighting with de-emphasis the one or more selectable items the selectable items incompatible with the functional operation; and operating the selected item by activating one of the one or more functional operations.
